(19) United States
(12) Patent Application Publication
(10) Pub. No.: US 2026/0029287 A1
(43) Pub. Date: Jan. 29, 2026

(54) TEST BENCHES TO CHECK CORRECT OPERATION OF TORQUE WRENCHES FITTED WITH VISUAL MONITORING SYSTEMS AND ACQUISITION OF WRENCH READINGS

(71) Applicant: ATLAS COPCO INDUSTRIAL TECHNIQUE AB, Stockholm (SE)

(72) Inventor: Nicolò FIORETTI, Solaro (MI) (IT)

(21) Appl. No.: 18/996,716

(22) PCT Filed: Jul. 25, 2023
(86) PCT No.: PCT/IB2023/057533

§ 371 Date: Jan. 17, 2025

(30) Foreign Application Priority Data
Jul. 26, 2022 (IT) 102022000015675

(51) Int. Cl. G01L 5/24

(52) U.S. Cl. CPC G01L 5/24

(57) ABSTRACT

A test bench to check correct operation of a torque wrench may include: at least one transducer including a first head configured to rotate and configured to couple with a second head of the wrench, wherein the wrench includes a first display configured to display parameters related to tightening, and wherein the at least one transducer is configured to measure the parameters related to the tightening exerted by the wrench; an electronic processing unit configured to control load exerted by the at least one transducer according to predetermined tightening programs which vary depending on the wrench; and a support station configured to receive the wrench. The station may be further configured to rotate around an axis, so that the first and second heads rotate in unison. The station may include at least one video camera configured to read the parameters related to the tightening from the first display.

The present invention refers to a test bench to check the correct operation of a torque wrench fitted with a visual monitoring system and acquisition of the wrench readings.

Such benches adapted to carry out said type of test are usually of two types. A first type comprises a transducer coupling with the tool head of the wrench which is a brake adapted to simulate the conditions of a joint; for example, it simulates the tightening of a bolt or a screw, having a hexagonal form or a frame on its head to which adapters can be added. Said bolt is tightened by the tightening instrument, in particular by the torque wrench to be tested. The tightening carried out by the wrench is simulated by rotating the wrench itself manually or by dedicated automatic mechanisms, simulating the tightening by an operator. A second type of test is carried out by using a transducer which is a motorized transducer (or static cell) which has a hexagonal form or a frame on its head, generally a form adapted to be coupled with the tool head of the wrench. The try is carried out by rotating the cited head of the transducer by the motor and meanwhile keeping the wrench in a stationary position with a dedicated locking mechanism.

The bench comprises an electronic processor which commands the electric or hydraulic circuit of the brake or the motorized transducer and which comprises a suitable driving program stored thereon.

The driving program, in the first-type bench, once selected the brake to be used for the test by an operator, is capable of progressively increasing the braking performance of the brakes and rotating the wrench until the rotation of the wrench itself is completely arrested.

Each brake is fitted with measure transducers connected with the electronic processing unit of the bench, which are able to detect the braking torque that the wrench exerts on the brake itself during tightening.

A test bench of said type is described in the patent application WO2019111146.

In the second type of bench, the one fitted with at least one motorized transducer, the torque wrench, is coupled therewith, so that the test is performed statically without rotating the wrench itself by blocking the wrench handle in the dedicated locking mechanism and rotating the head of the transducer by said suitable driving program with which the wrench is coupled. Indeed, the head of the transducer simply tensions the wrench applying a torque, the wrench itself does not rotate due to the presence of the locking mechanism.

The present invention applies to a bench which can have different test modules, of both the first and the second type. Brakes adapted to carry out dynamic tests, in which the wrench rotates, and motorized transducers adapted to carry out static tests in which the wrench does not rotate can be present in the same bench.

Depending on the length of the wrench overall, the locking mechanism of the wrench handle, referred to as reaction bar, should be able to move longitudinally, so that the clamp of the bar is positioned substantially at the wrench handle.

The test procedure of a torque wrench can require different steps and include different measurements. It is an activity which is prepared for human error and involves problems of repeatability due to the dependence on the operator and also between different tightenings of the same operator.

If the wrench under test is a mechanical torque wrench, the purpose of the test is to verify the operation in torque thereof. Typically, the wrench is adjusted to signal the pre-selected torque level, verifying the accuracy and the repeatability thereof. In practice, the signalled value of the wrench is compared with that acquired by the sensors of the bench and a series of measurements to obtain statistic indexes thereof are carried out. The test on this typology of wrenches can be totally automatized on a bench, since the entire cycle of applying the torque by motor, detecting the signal, and acquiring the corresponding torque on transducer, can be totally managed by the bench for the entire test cycle, without intervention of the operator. The intervention of the operator is limited to setting the wrench under test, programming the parameters required for the test on the bench, starting the test. The test results can be retrieved later once the test is completed. With the known technology at the state of the art, performing these tests, i.e., the longest part in terms of time and the most delicate in terms of measure, can be totally automatized on the bench, and take place without the human presence of an operator.

If the wrench under test is a torque wrench with displaying of the measure (Type I according to the ISO classification), it can be dial mechanical, or more frequently electronic, provided with a usually graphic alphanumeric display. For the latter, in addition to the operation in torque thereof, the operation in angle can also be usually verified since they are often provided with systems for directly or indirectly measuring the angle of rotation impressed on the screw. For the wrenches providing the measure, verifying the measure provided by the wrench, comparing it with that detected by the reference instrument, is required. In particular, for torque-angle tests carried out on a bench, the value(s) indicated by the wrench (only torque or torque and angle) is/are compared with that/those acquired by the sensors of the bench. Even in this case, carrying out a series of measurements is required to obtain statistic indexes.

In contrast to the case of the test on bench of mechanical wrenches, only signalling the reaching of the torque level, the test of torque wrenches indicating the measured values is more complex to be automatized. Indeed, while using a test bench capable of applying torque by motor in the two known modes (with the wrench blocked on a static transducer for only-torque tests and rotating the wrench on a simulated joint/brake for torque-angle tests), and while being able to automatically acquire the measures of torque and angle directly from the bench instrument, acquiring the measure values indicated by the wrench is required to complete the single measure cycle. If this acquisition is also made automatically, the entire test cycle, even for this typology of wrench, can be totally managed by the bench without intervention of the operator.

Acquiring the measurements from the wrench has the greatest issue. In the known art, in this scenario, the possibility of a direct cable or wireless connection of the wrench with the processing unit of the bench is provided. Said option is however severely limited by the following factors: not all the electronic torque wrenches have a communication data interface and not all the electronic torque wrenches provide protocols to transfer the measure suitable to these applications.

For wrenches provided with both, a supported universal protocol for this type of test being implementable by the bench does not exist.

According to the known art, in order to totally automatize the performing of the test cycle of the electronic torque wrenches, limited to the models provided with interface and suitable protocol (if made available by the manufacturer), the bench should singularly implement the specific protocol for the particular model to be tested. Without these conditions, a test cycle of the same cannot be totally automatized by the bench.

More commonly, when the test cannot be totally automatized on the bench, it occurs that the human operator should attend the test cycle for the entire duration thereof and, at each measurement, should read (with his/her eyes) the values indicated on the wrench display and manually digit them on a suitable user interface arranged on the bench, so that the same can compare them with the corresponding ones automatically acquired by the reference internal transducers thereof.

The Applicant has raised the problem of how to automatize said test when the wrench has not an interface for communicating with the bench, or if the interface cannot be used for any reason.

The present invention proposes a test bench to check the correct operation of a torque wrench having the features of the enclosed claim 1.

Further features of the present invention are contained in the dependent claims.

The features and advantages of the present invention will be more apparent from the following description of an exemplary and non-limiting embodiment of the invention, referred to the attached schematic drawings, in which:

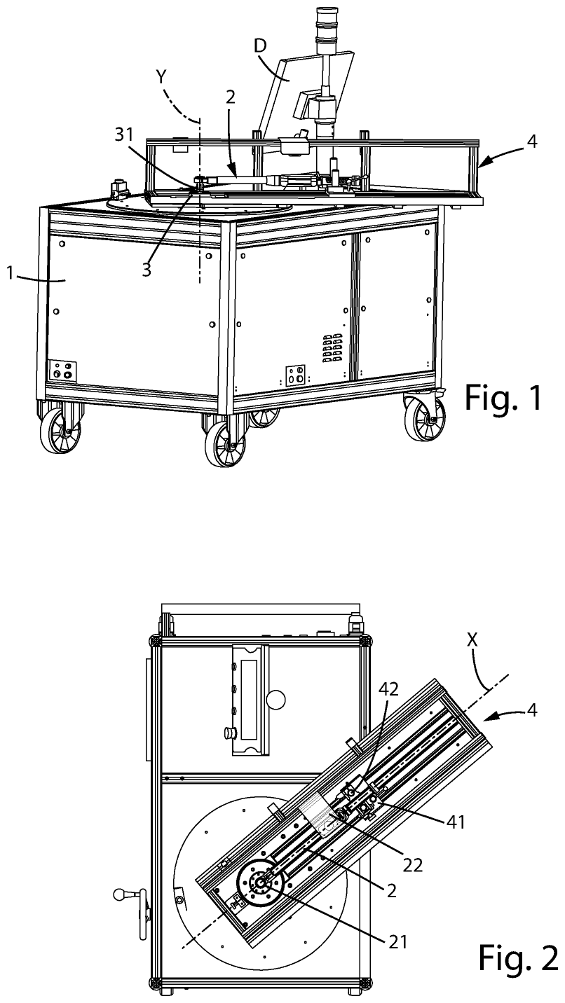

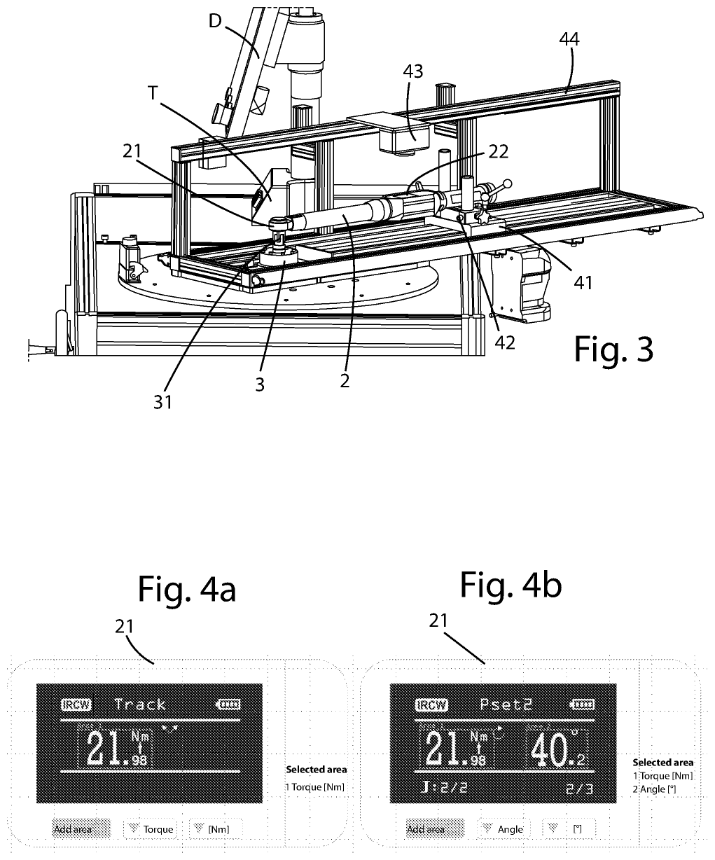

FIG. 1 illustrates a perspective schematic view of the test bench according to the present invention;
FIG. 2 illustrates the bench of FIG. 1 in a top view;
FIG. 3 illustrates the visual monitoring system of the wrench placed on the bench of FIG. 1;
FIGS. 4a and 4b illustrate two possible configurations of the display of a torque wrench placed on the bench according to the present invention.

With reference to the cited figures, the test bench 1 to check the correct operation of a torque wrench 2 according to the illustrated embodiment of the present invention comprises at least one transducer 3 having a rotating head 31 adapted to be coupled with a tool head 21 of a torque wrench 2 to be analysed, which is positioned on a support station 4.

The torque wrench to be analysed is of the type fitted with a display 22 in which, inter alia, parameters relating to the tightening in progress, such as for example torque exerted and/or angle of rotation, are displayed.

Said support station is able to rotate around a vertical axis Y corresponding to the rotation axis of the head 31 of the transducer, so that the tool head of the wrench and the head of the transducer rotate in unison. The coupling typically takes place as the head has a hexagonal form or frame.

Said transducer can be motorized or not and simulates the conditions of a joint; for example, it simulates the tightening of a bolt or a screw and is able to measure parameters of the tightening exerted by said wrench.

Examples of such parameters are the torque exerted and/or the angle of rotation or other parameters that the wrench is able to detect and show during tightening.

When said transducer is motorized, the try can take place by rotating the coupled head of the transducer with the torque wrench applying a predetermined load (torque exerted), while the support station 4 keeps the wrench stationary. Said transducer can be motorized or not and simulates the conditions of a joint; for example, it simulates the tightening of a bolt or a screw. When said transducer is not motorized, the try can take place by rotating the support structure 4 with the wrench C fixed thereon. The latter configuration is typically used in order to allow to verify the angle reading of the wrench.

The bench further comprises an electronic processing unit, preferably provided with a suitable display D and user interface T which controls the load exerted by the transducer according to predetermined tightening programs according to the type of wrench to be tested.

Such support station 4 comprises a frame at the base of which a slide 41 is mounted which can slide along a longitudinal axis X corresponding to the longitudinal axis of the wrench 2 and on which a locking mechanism 42 of the wrench handle is mounted. In this way, wrenches having lengths even very different from each other can be positioned on the station, by simply sliding the slide to the most suitable position to lock the handle.

According to the present invention, the support station comprises at least one video camera 43 positioned so as to frame the display 22 of the wrench 2 under test and capable of reading said wrench tightening parameters from the wrench display.

Such video camera 43 slides on a guide 44 associated with said frame, so as to be able to slide along the aforementioned longitudinal axis X of the wrench and be positioned exactly in correspondence with the display 22 of the wrench 2.

The video camera is controlled by the electronic processing unit of the bench, which comprises a program for decoding/reading the wrench display (for example comprising typical computer vision instruments and an OCR module), so as to read the values of the tightening parameters from the display itself.

The bench according to the present invention operates as follows.

Once blocked the wrench on the support station by the slide and the locking mechanism, the video camera is positioned at the wrench display.

Before starting an automatic test cycle, a step of configurating the areas on the display from which the reading of the measures is carried out specifically for a model or a model family of electronic torque wrench is carried out. For this purpose, the decoding/reading program provides a graphic instrument for selecting the areas of the wrench display and associating the read quantity therewith. In FIGS. 4a and 4b two typical wrench displays in which the values of torque exerted (FIG. 4a) and the exerted values of torque and angle (FIG. 4b) are displayed are illustrated.

The video camera can be advantageously movable around its framing axis. Said position of the camera for correct framing can be adjusted also using the decoding/reading program.

Then, the test is performed with the classic setup of the bench even configuring the try, for example indicating the «cycle complete» parameter (i.e., how long after the end of the tightening the measure is stable and definitive, can be acquired).

Alternatively, the decoding/reading program can be contained directly in the video camera, instead of in the processing unit of the bench.

When the automatic test on the bench starts and the electronic wrench starts measuring, the video camera is activated, and the decoding/reading program processes the sequence of images of the display. The numerical values on the display are thus recognized and acquired. Thus, the bench automatically acquires the measurements of the wrench under test and applies the intended logics of evaluating and comparing with the other measures available from the reference transducers 3.

Thus, the bench can automatically complete the entire test cycle for any electronic torque wrench without intervention of a human operator. This solution allows to automatically also manage the test cycles which provide for reaching the target values on the measurements indicated by the electronic torque wrench and instead of by the internal transducer of the bench. Indeed, in order to carry out totally automatized tests, the bench uses algorithms which control the motor to put the wrench in torque, arresting it upon reaching the target values provided by the test. More commonly, the bench monitors the measurements acquired by the transducers thereof, while a number of technical regulations provide operation procedures for tests in which the measurements to be monitored for reaching the target are those of the wrench (es: ISO 6789:2017). This typology of test can be automatized on the bench only by acquiring the measurements of the wrench, which will be also used for controlling the motor for applying the torque. The proposed solution allows this scenario, setting a suitable acquisition frequency to allow an effective control.

1. A test bench to check correct operation of a torque wrench, the test bench comprising:
at least one transducer having a rotating head adapted to be coupled with a tool head of a torque wrench to be tested, wherein the torque wrench is equipped with a display in which parameters related to tightening are displayed, and wherein the at least one transducer is configured to measure the parameters related to the tightening exerted by the torque wrench to be tested;
an electronic processing unit that controls load exerted by the at least one transducer according to predetermined tightening programs according to a type of the torque wrench to be tested; and
a support station on which the torque wrench to be tested is positioned;
wherein the support station is configured to rotate around a vertical axis corresponding to a rotation axis of a head of the at least one transducer, so that the tool head of the torque wrench to be tested and the rotating head of the at least one transducer rotate in unison, and
wherein the support station comprises at least one video camera positioned so as to frame the display of the torque wrench to be tested and capable of reading the parameters related to the tightening from the display.

2. The test bench of claim 1, wherein the support station comprises a frame at a base of which a slide is mounted which can slide along a longitudinal axis corresponding to a longitudinal axis of the torque wrench and on which a locking mechanism of a handle of the torque wrench is mounted.

3. The test bench of claim 2, wherein the at least one video camera slides on a guide associated with the frame, so as to slide along the longitudinal axis of the torque wrench and to position itself exactly in correspondence with the torque wrench display.

4. The test bench of claim 1, wherein the at least one video camera is controlled by the electronic processing unit of the test bench, the electronic processing unit comprising a decoding/reading program of the torque wrench display, so as to read values of the parameters related to the tightening from the torque wrench display.

5. The test bench of claim 1, wherein the at least one video camera comprises a program for decoding/reading the torque wrench display, so as to read values of the parameters related to the tightening from the torque wrench display.

6. The test bench of claim 1, in which the at least one transducer is motorized, and wherein the test takes place by rotating the coupled head of the at least one transducer with the torque wrench applying a predetermined load, while the support station keeps the torque wrench stationary.

7. The test bench of claim 1, in which the at least one transducer is motorized, and wherein the test takes place by rotating the support station with the torque wrench fixed thereon.

8. The test bench of claim 1, wherein the parameters related to the tightening include one or more of torque exerted, angle of rotation, or other parameters that the torque wrench is able to detect and show during tightening.

9. The test bench of claim 1, wherein the at least one video camera can be moved around its framing axis.

10. The test bench of claim 1, wherein the position of the at least one video camera for correct framing can be adjusted using a decoding/reading program.

11. A test bench to check correct operation of a torque wrench, the test bench comprising:
at least one transducer comprising a first head configured to rotate and configured to couple with a second head of the torque wrench, wherein the torque wrench comprises a first display configured to display parameters related to tightening, and wherein the at least one transducer is configured to measure the parameters related to the tightening exerted by the torque wrench;
an electronic processing unit configured to control load exerted by the at least one transducer according to predetermined tightening programs which vary depending on the torque wrench; and
a support station configured to receive the torque wrench;
wherein the support station is further configured to rotate around a vertical axis corresponding to a rotation axis of the first head, so that the first and second heads rotate in unison, and
wherein the support station comprises at least one video camera configured to read the parameters related to the tightening from the first display.

12. The test bench of claim 11, wherein the support station further comprises a slide configured to move along an axis corresponding to a longitudinal axis of the torque wrench.

13. The test bench of claim 11, wherein the support station further comprises a locking mechanism for a handle of the torque wrench.

14. The test bench of claim 11, wherein the support station further comprises a guide configured to allow the at least one video camera to move depending on the torque wrench.

15. The test bench of claim 11, wherein the electronic processing unit is further configured to control the at least one video camera.

16. The test bench of claim 11, wherein the electronic processing unit comprises a program for decoding/reading the first display.

17. The test bench of claim 11, wherein the at least one video camera comprises a program for decoding/reading the first display.

18. The test bench of claim 11, wherein the at least one transducer is motorized, and
wherein the torque wrench is tested by rotating the coupled first and second heads, with the torque wrench applying a predetermined load, while the support station keeps the torque wrench stationary.

19. The test bench of claim 11, wherein the at least one transducer is motorized, and
wherein the torque wrench is tested by rotating the support station with the torque wrench fixed to the support station.

20. The test bench of claim 11, wherein the parameters related to the tightening comprise one or more of:
torque exerted;
angle of rotation; or
one or more other parameters that the torque wrench displays during the tightening.
